(19) United States
(12) Patent Application Publication
(10) Pub. No.: US 2024/0108957 A1
(43) Pub. Date: Apr. 4, 2024

(54) Paddle Hanger

(71) Applicant: Tanners Team Sports, Inc., Hot Springs, AR (US)

(72) Inventor: Vincent Martin Signorelli, Hot Springs, AR (US)

(21) Appl. No.: 17/959,522

(22) Filed: Oct. 4, 2022

(51) Int. Cl. A63B 60/58; F16B 2/08

(52) U.S. Cl. CPC A63B 60/58; F16B 2/08

(57) ABSTRACT

A hanger for safely displaying and storing paddles, such as pickleball paddles, is disclosed. The hanger has a top piece that includes a channel for receiving a top edge of the paddle and a connector portion extending downward from the channel, two bottom pieces with channels for receiving opposing side edges of the paddle, and an elastic band connecting the connector portion to the two support pieces.

### CROSS-REFERENCE TO RELATED APPLICATIONS

Not applicable

### STATEMENT REGARDING FEDERALLY SPONSORED RESEARCH OR DEVELOPMENT

Not applicable

### BACKGROUND OF THE INVENTION

The sport of pickleball is one of the fastest growing sports in the United States. With the growth in the game, the number of pickleball paddles offered for sale and sold is on the rise. Because of their structure and shape, pickleball paddles are difficult to display for sale and for safe storage. It would therefore be desirable to develop a paddle hanger that easily attaches to the paddle and is used for safely displaying and storing paddles.

### BRIEF SUMMARY OF THE INVENTION

The present invention is directed to a paddle hanger having a top piece configured to receive a top edge of a paddle and a connector portion for extending along a back surface of the paddle, a first bottom piece configured to receive a first side edge of the paddle, a second bottom piece configured to receive a second side edge of the paddle, and an elastic band connecting the first bottom piece and the second bottom piece and threaded through eyelets in the connector portion.

The present invention is also directed to a paddle hanger having a top piece including a channel configured to receive a top edge of a paddle and a connector portion extending downward from the channel, a first bottom piece comprising a channel configured to receive a first side edge of the paddle, a second bottom piece comprising a channel configured to receive a second side edge of the paddle, and an elastic band connecting the connector portion to the first bottom support piece and the second bottom support piece.

These and other features, objects and advantages of the present invention will become better understood from a consideration of the following detailed description of the preferred embodiments and appended claims in conjunction with the drawings as described following:

### BRIEF DESCRIPTION OF THE DRAWINGS

FIG. 1 is a front perspective view of the paddle hanger of the present invention holding a paddle.

FIG. 2 is a back perspective view of the paddle hanger of the present invention holding a paddle.

FIG. 3 is a front perspective view of the paddle hanger of the present invention.

FIG. 4 is a front view of the paddle hanger of the present invention.

FIG. 5 is a back view of the paddle hanger of the present invention.

FIG. 6 is a left side view of the paddle hanger of the present invention.

FIG. 7 is a right side view of the paddle hanger of the present invention.

FIG. 8 is a top view of the paddle hanger of the present invention.

FIG. 9 is a bottom view of the paddle hanger of the present invention.

### DETAILED DESCRIPTION OF THE INVENTION

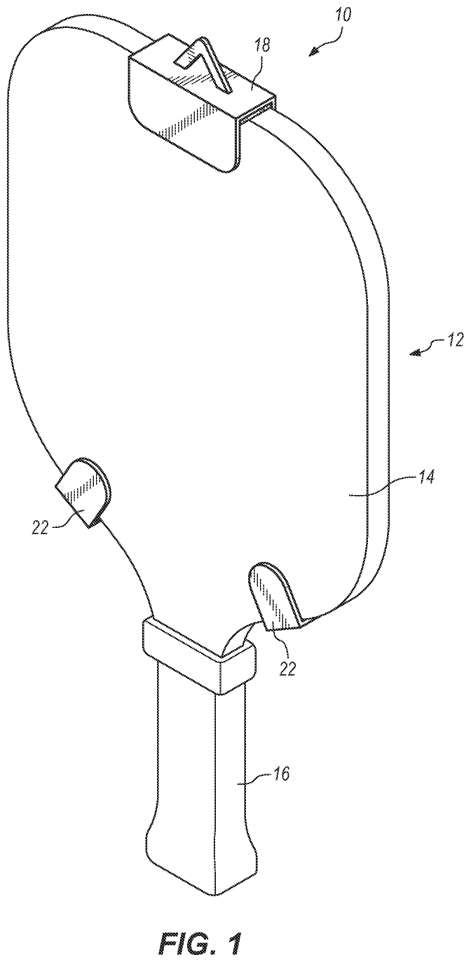

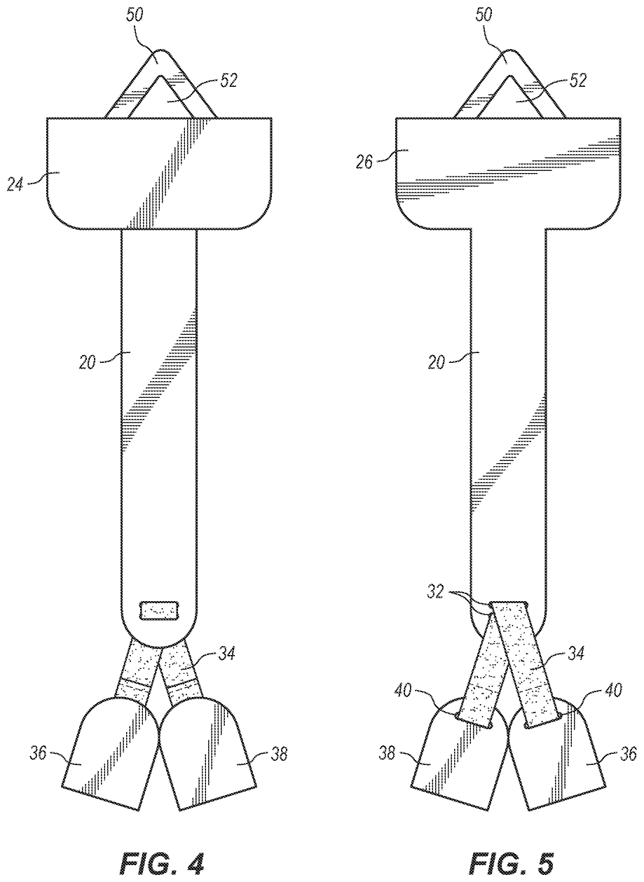

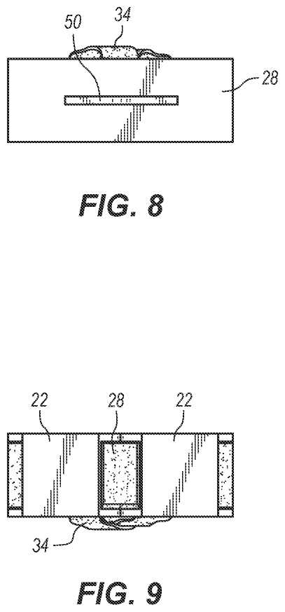

With reference to FIGS. 1-9, the preferred embodiments of the paddle hanger of the present invention may be described. A paddle 12, such as pickleball paddle, includes a striking head 14 attached to a handle 16. While the invention may be described with respect to a pickleball paddle, the invention is not so limited and may be used with any paddle or racket having a striking head and a handle.

The paddle hanger 10 securely attaches to the striking head 14 of the paddle 12, and then the hanger 10 with the paddle 12 may be attached to a peg for display or storage.

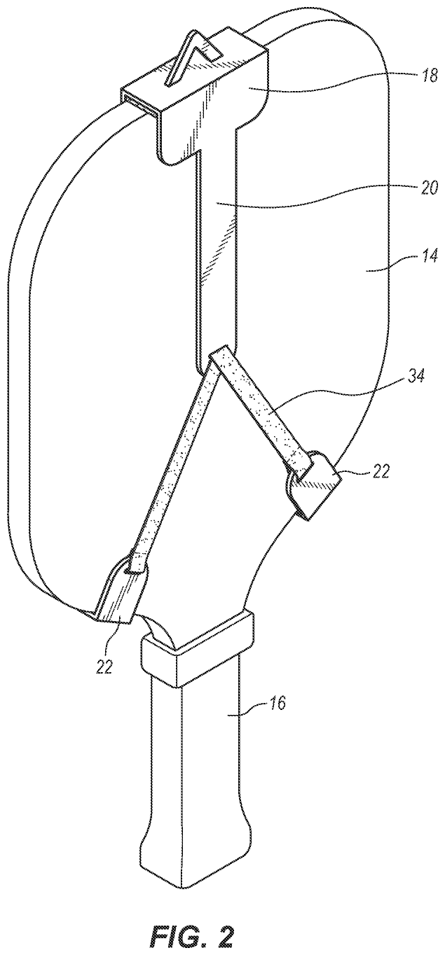

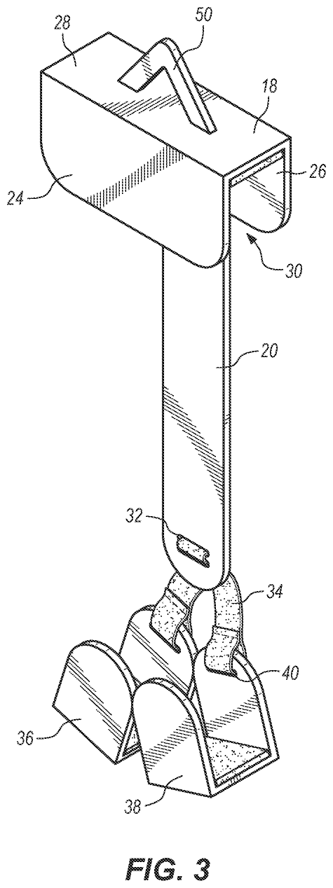

The paddle hanger 10 includes a top piece 18 configured to receive the top edge of the striking head 14 and having a connector portion 20. The paddle hanger 10 also includes two bottom pieces 22 configured to receive opposing side edges of the striking head. The connector portion 20 serves as the spine of the paddle hanger 10. The top piece includes a front plate 24, a back plate 26, and a top plate 28. A channel 30 is formed in the space between the front plate 24, back plate 26, and top plate 28. The channel 30 is sized to receive the top edge of the paddle 12 (i.e., the edge of the paddle opposite the handle), as shown in FIGS. 1-2. In one embodiment, a cushion is attached to the bottom surface of the top plate (as shown in FIG. 3) and therefore is attached in the channel 30. The cushion permits the top piece to be secured to the top edge of the striking head tightly and without slippage. The connector portion 20 is vertically oriented and is joined at its top edge to the bottom of the back plate 26 of the top piece 18. The connector portion 20 serves as the spine of the paddle hanger and provides support when positioned along the back of the striking head of the paddle, as shown in FIG. 2.

The connector portion 20 includes eyelets 32 that are positioned towards the free end of the connector portion 20. An elastic band 34 is threaded through the eyelets 32. One end of the elastic band 34 is attached to the first bottom piece 36, and the opposite end of the elastic band 34 is attached to the second bottom piece 38. In one embodiment, the two bottom pieces 34, 36 (or collectively, 22) each have an eyelet 40 for receiving the elastic band 34. Because of the elastic band 34, the paddle hanger 10 can fit different sized paddles because the elastic band attached to the bottom pieces may be stretched to attach to larger paddles.

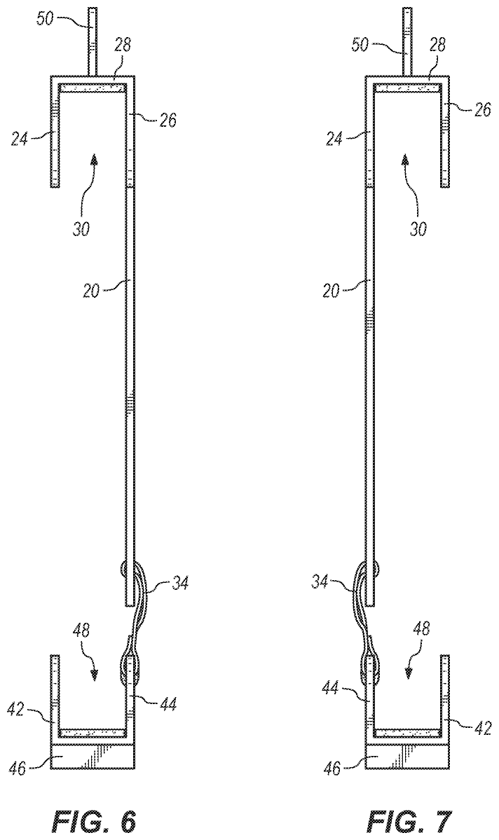

The bottom pieces 34, 36 (or collectively, 22) include a front plate 42, a back plate 44, and a bottom plate 46. A channel 48 is formed in the space between the front plate 42, back plate 44, and bottom plate 46. The channel 48 is sized to receive the side angled edges of the paddle, as shown in FIGS. 1-2. The side angled edges are the edges of the paddle that are descending to the neck of the paddle attached to the handle 16 of the paddle 12. In one embodiment, a cushion is attached to the top surface of the bottom plate of each of the bottom pieces (as shown in FIGS. 6-7). In that regard, the cushion is attached in the channel 48. The cushion permits the bottom pieces 34, 36 to be secured to the side angled edges of the striking head tightly and without slippage. In an alternative embodiment, the bottom pieces 34, 36 may be secured to other sides edges of the striking head of the paddle besides the side angled edges.

A hanging piece 50 is attached to the top plate 28 of the top piece 18. An opening 52 is created between the hanging piece 50 and the top plate 28 of the top piece 18. A peg may be received through the opening 52 to hang the paddle hanger with the attached paddle for display or storage. In one embodiment, the hanging piece is an arch. The shape of the arch may vary, but a triangular arch is shown in FIGS. 1-5.

The present invention has been described with reference to certain preferred and alternative embodiments that are intended to be exemplary only and not limiting to the full scope of the present invention as set forth in the appended claims.

1. A hanger, comprising:
a top piece configured to receive a top edge of a paddle, wherein said top piece comprises a connector portion;
a first bottom piece configured to receive a first side edge of said paddle;
a second bottom piece configured to receive a second side edge of said paddle; and
an elastic band comprising a first end and a second end, wherein said first end of said elastic band is connected to said first bottom piece and said second end of said elastic band is connected to said second bottom piece, wherein said elastic band passes through said connector portion.

2. The hanger of claim 1, wherein said connector portion comprises a first eyelet and a second eyelet.

3. The hanger of claim 2, wherein said elastic band is received through said first eyelet and said second eyelet.

4. The hanger of claim 1, wherein said top piece comprises a channel.

5. The hanger of claim 4, wherein a cushion is attached in said channel.

6. The hanger of claim 1, wherein said first bottom piece comprises a first bottom piece channel and said second bottom piece comprises a second bottom piece channel.

7. The hanger of claim 6, wherein said a cushion is attached in said first bottom piece channel and wherein a cushion is attached in said second bottom piece channel.

8. The hanger of claim 4, wherein said channel of said top piece is sized to receive said top edge of said paddle.

9. The hanger of claim 6, wherein said first bottom piece channel is sized to receive said first side edge of said paddle and wherein said second bottom piece channel is sized to receive said second side edge of said paddle.

10. The hanger of claim 1, wherein said connector portion of said top piece is configured to extend along a back surface of said paddle.

11. The hanger of claim 1, further comprising a hanging piece attached to said top piece.

12. The hanger of claim 11, wherein said hanging piece comprises an opening for receiving a peg.

13. The hanger of claim 12, wherein said hanging piece is arch-shaped.

14. A hanger, comprising:
a top piece comprising a channel configured to receive a top edge of a paddle, wherein said top piece further comprises a connector portion extending downward from said channel;
a first bottom piece comprising a channel configured to receive a first side edge of said paddle;
a second bottom piece comprising a channel configured to receive a second side edge of said paddle; and
an elastic band connecting said connector portion to said first bottom support piece and to said second bottom support piece, wherein a first end of said elastic band is connected to said first bottom piece and a second end of said elastic band is connected to said second bottom piece.

15. The hanger of claim 14, wherein said connector portion comprises a first eyelet and a second eyelet, wherein said elastic band is received through said first eyelet and said second eyelet.

16. The hanger of claim 14, further comprising a hanging piece attached to said top piece, wherein said hanging piece comprises an opening for receiving a peg.
